(19) United States
(12) Patent Application Publication
(10) Pub. No.: US 2006/0019797 A1
(43) Pub. Date: Jan. 26, 2006

(54) Input shaft brake

(75) Inventors: Wade Alan Smith, Imlay City, MI (US); Troy Scott Reinoehl, Ashley, IN (US); Kevin F. Schlosser, Auburn, IN (US)

Correspondence Address: Kevin J. Heinl;Brooks Kushman P.C., 22nd Floor, 1000 Town Center, Southfield, MI, 48075-1238, US

(73) Assignee: EATON CORPORATION, Cleveland, OH (US)

(21) Appl. No.: 10/899,280

(22) Filed: Jul. 26, 2004

(51) Int. Cl. B60K 41/20

(52) U.S. Cl. 477/92

(57) ABSTRACT

An input shaft brake is provided for a transmission. The input shaft brake may have a hydraulically or pneumatically actuated piston and may have a single brake disk or double brake disk that are disposed on one or both sides of an input shaft rotor is retained on an input shaft. The brake may alternatively be comprised of a rotor made with friction material and at least one member mounted for axial movement that engage one or both sides of the rotor when force is applied by a piston. Braking force is applied to the input shaft disk to allow for quicker shifting and synchronizer engagement.

### BACKGROUND OF THE INVENTION

1. Field of the Invention

The present invention relates to a vehicle transmission system that has an input shaft brake disposed between a clutch and a multiple speed gear transmission.

2. Background Art

Vehicles are provided with transmissions that provide multiple gear ratios for different power and speed requirements. Many different types of transmissions have been developed, including manual transmissions, automatic transmissions and automated shift transmissions. Automatic transmissions are generally provided for cars and light trucks that provide fully automatic shifting by means of a complex hydraulic and electronic control system. Manual transmissions are simpler and generally require manual disengagement of a clutch and manual movement of a shift lever to engage different gear ratios. Automated shift manual transmissions have been developed that provide the convenience of an automatic transmission but are shifted by means of X-Y shift control motors that move a shift lever in manual transmissions.

Each of the above-described transmission systems may be provided with a synchronizing system that synchronizes a selected gear with a rotating input shaft. The synchronizing system facilitates smooth shifting without the noise caused by a failure of gears to properly mesh as they are engaged. Prior art automated shift transmissions are generally coupled to an input shaft without a brake. Synchronizing systems cause input shaft supported gears and output shaft supported gears to rotate at near synchronous speeds. Synchronizing systems add cost and weight to transmissions synchronizing systems require time to synchronize rotation of gears and can delay shifting operations.

One approach to permit more rapid shift performance is to provide an inertia brake that is mounted to a transmission power takeoff location. An inertia brake mounted at a power takeoff location can be used to slow shaft rotation and may allow shifts to be synchronized more rapidly. One disadvantage of power takeoff mounted inertia brakes is that such devices add weight to the transmission that can adversely impact fuel economy. Another disadvantage is that assembling a power takeoff mounted inertia brake to the transmission increases the cost of parts and labor. In addition, mounting the inertia brake to a power takeoff location makes that power takeoff location unavailable for other purposes.

In the design of transmissions, of any type, it is an objective to provide capability to shift more quickly and smoothly. By providing quicker shifts, transmission performance and efficiency may be improved.

There is a need for a low cost system for providing quicker shifts by allowing more rapid transmission gear synchronization. The present invention is directed to improving transmission performance and providing quicker shifting capability as summarized below.

### SUMMARY OF THE INVENTION

According to one aspect of the present invention, a combination of a vehicle engine, a multiple ratio geared transmission and an input shaft inertia brake is provided. The input shaft inertia brake is secured to an input shaft and is at least partially disposed in a housing. The input shaft is disposed between the crankshaft of the engine and the transmission. In one embodiment of the invention the input shaft brake may comprise a rotor, or disk, secured to the input shaft and a brake piston that is axially shiftable relative to the input shaft. At least one member is grounded to the housing and mounted adjacent to one side of the rotor for relative axial movement. A second member may also be grounded to the housing and mounted adjacent to another side of the rotor for relative axial movement. A fluid cavity is defined by the housing and one side of the brake piston. At least one fluid port (hydraulic or pneumatic) is provided in the housing that is in fluid flow communication with the fluid cavity so that fluid supplied to the cavity through the fluid port may selectively move the rotor and at least one of the members into engagement. A return spring may be provided that applies a biasing force to urge the members out of engagement with the rotor.

According to another aspect of the present invention, a transmission system for a vehicle having an engine is provided with an inertia brake between a clutch and the transmission. The clutch is operatively connected to the engine to selectively transfer torque from the engine. A multiple speed gear transmission has an input shaft that receives torque from the engine through the clutch. The input shaft is at least partially disposed within a housing located between the engine and the transmission. The inertia brake in one embodiment may comprise a rotor that is secured to the input shaft and a brake piston that is axially movable relative to the input shaft. The brake may further comprise first and second members that are grounded to the housing and are mounted for relative axial movement on opposite sides of the disk. A fluid cavity is defined on one side of the brake piston. At least one fluid port is provided in the housing that is in fluid flow communication with the fluid cavity on the one side of the brake piston. Fluid supplied to the cavity through the fluid port moves the piston into engagement with the first member that shifts relative to the rotor and may also shift the rotor into engagement with the second member. A return spring biases the first end second members out of engagement with the rotor.

Other aspects of the invention relate to a control system that may be provided to control gear selection. The brake piston may be actuated during a shift operation upon a determination that it is desired to change gears. The control system may be a hydraulic or pneumatic control system. The control system may have a first sensor for determining the speed of rotation of the input shaft and a driving gear attached to the input shaft. A second sensor may be provided for determining the speed of rotation of a driven gear in the transmission. The control system controls application of the inertia brake to reduce the speed of rotation of the input shaft and facilitate engagement of the drive gear and driven gear.

According to another aspect of the invention, the return spring may apply a biasing force to the brake piston indirectly by engaging the first and second disk brake plates to separate them from each other. The return spring may be disposed in the housing adjacent a radially outer margin of the disk that is secured to the input shaft.

According to other aspects of the invention, anti-rotation means may be provided to prevent rotation of the piston and/or the first and second members. The anti-rotation means may comprise bosses formed in the housing that are receptacles by cooperating receptacles in the piston. Alternatively, the anti-rotation means may be axially extending recesses in the housing that receive tabs, ears, or other protrusions formed on the piston or first and second members. The anti-rotation means may also comprise dowel pins or bolts that connect or ground the piston, first and second members or a bearing cap to the housing.

According to another aspect of the invention, a method of controlling a multiple speed transmission system of a vehicle is provided in which an input shaft brake is utilized to reduce the speed of rotation of the input shaft. According to the method, a transmission system is provided that has a clutch and an input shaft brake that is disposed between a crankshaft of the engine and the multiple speed transmission portion of the transmission system. A controller has a first sensor associated with the input shaft and a second sensor associated with an output shaft. The method further comprises determining the speed of rotation of a first rotating component with the first sensor while also determining the speed of rotation of a second rotating component with the second sensor. Next, the input shaft brake is actuated to apply a braking force to reduce the speed of rotation of the input shaft. The input shaft is coupled to the output shaft through the transmission when the speed rotation of the first and second rotating components are matched to within a predetermined degree of speed differential.

According to a further aspect of the invention as it relates to the method, a synchronizer may be provided in the transmission that synchronizes a drive gear with a driven gear. Application of the input shaft brake may be used to reduce the speed of rotation of the input shaft and allow the synchronizer to synchronize the drive gear and driven gear in less time. Alternatively, the transmission may be provided without a synchronizer and the inertia brake may provide the sole mechanism for matching the speed of rotation of the drive gear and driven gear.

### BRIEF DESCRIPTION OF THE DRAWINGS

FIG. 1 is a schematic diagram of an engine and a multiple speed geared transmission made according to one embodiment of the present invention;

FIG. 2 is a fragmentary cross-sectional view of an input shaft brake made according to one embodiment of the present invention;

FIG. 3 is a fragmentary exploded perspective view of the input shaft brake as illustrated in FIG. 2;

FIG. 4 is a fragmentary cross-sectional view of an input shaft brake made according to one alternative embodiment of the present invention;

FIG. 5 is a fragmentary exploded perspective view of the input shaft brake illustrated in FIG. 4;

FIG. 6 is a fragmentary cross-sectional view of an input shaft brake made according to another alternative embodiment of the present invention;

FIG. 7 is a fragmentary cross-sectional view of an input shaft brake made according to another alternative embodiment of the present invention;

FIG. 8 is a fragmentary cross-sectional view of an input shaft brake made according to another alternative embodiment of the present invention;

FIG. 9 is a fragmentary perspective partially cut-away view of another alternative embodiment of the present invention;

FIG. 10 is a fragmentary cross-sectional view of an input shaft brake made according to another alternative embodiment of the present invention;

FIG. 11 is a fragmentary perspective partially cut-away view of another alternative embodiment of the present invention; and

FIG. 12 is a fragmentary cross-sectional view of an input shaft brake made according to another alternative embodiment of the present invention.

### DETAILED DESCRIPTION OF THE PREFERRED EMBODIMENT(S)

Referring to FIG. 1, a transmission system 10 for a vehicle engine 12 is schematically illustrated. The engine 12 has a crankshaft 14 that is connected through a clutch 16 to an input shaft 18. An input shaft brake 20 is assembled to the input shaft 18. The input shaft 18 is connected to a multi-speed gear transmission 22 that is controlled by a controller 24. Controller 24 monitors transmission operations and may also monitor engine operations. The controller may also obtain data from other signal sources as is well known in the art. For example, a rotation sensor 26 may be provided to monitor the speed of rotation of the input shaft 18. The controller 24 may also receive data from an engine speed tachometer or the engine controller 28. A wide variety of sensors may be used to provide data to the controller 28.

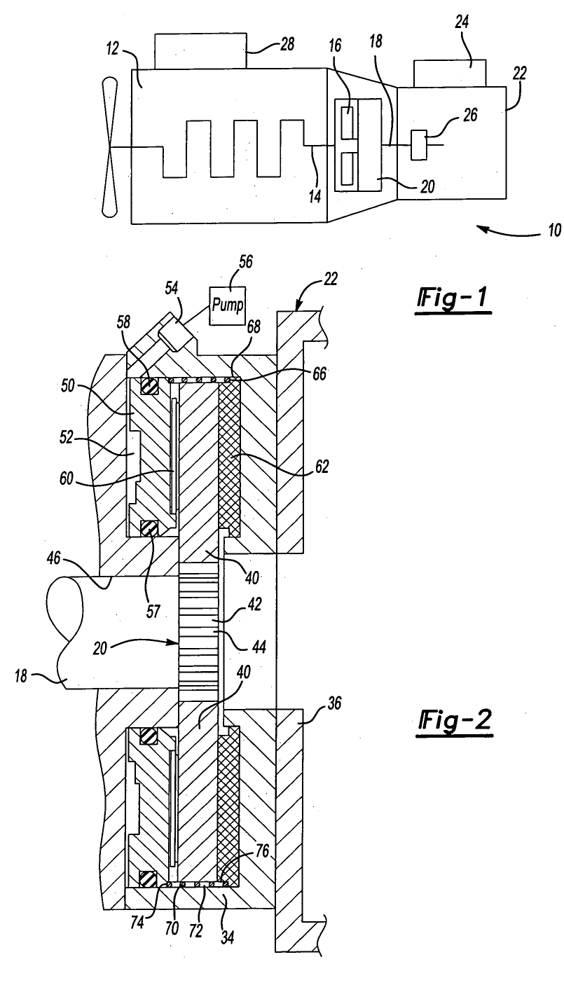

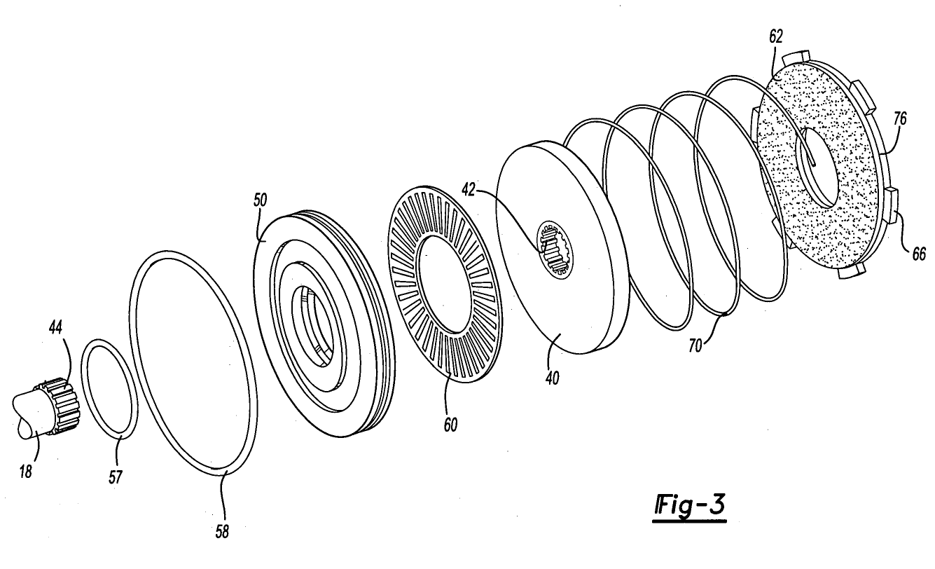

Referring to FIGS. 2 and 3, a portion of a transmission 22 is shown that is adapted to receive torque from an input shaft 18 of the engine 12. An inertia brake housing 34 encloses an input shaft brake 20 and is either secured to or integrally formed with the transmission housing 36. Input shaft brake 20 has a disk 40, or rotor, having splines 42 formed on its inner diameter that are engaged by and mate with splines 44 formed on the input shaft 18. Input shaft 18 is received within an opening 46 in the inertia brake housing 34.

A brake piston 50 is disposed in a chamber 52 defined within the inertia brake housing 34. A port 54 opening into the chamber 52 is connected to a source of control fluid such as a hydraulic pump or air compressor 56. The hydraulic pump or air compressor 56 is controlled by the transmission controller 24. Control fluid is used to shift the brake piston 50 within the chamber 52 when pressurized fluid is injected into the port 54 under pressure.

The brake piston 50 has an inner O-ring seal 57 and an outer O-ring seal 58 that seal between the piston 50 and the chamber 52 as the brake piston 50 is moved.

A thrust bearing 60 is provided between the brake piston 50 and the input shaft disk 40. The input shaft disk 40 rotates with the input shaft 18 while the brake piston 50 does not rotate.

A brake disk 62 is formed of a friction material and is retained in the inertia brake housing 34 by grounding teeth 66 that are received in recesses 68 formed in the transmission housing 36. The brake disk 62 is prevented from rotating by the grounding teeth 66 that are held by the recesses 68.

A return spring 70 is disposed in an annular space 72 defined between the outer diameter of the input shaft disk 50 and the inertia brake housing 34. Return spring 70 exerts a biasing force against the brake piston 50 to bias the brake piston 50 into a disengaged position. The return spring 70 is received in an annular groove 74 formed in the brake piston 50 on one end and on the other end is received in an annular seat 76 formed by the brake disk 62 and inertia brake housing 34.

In operation, when the transmission is to be shifted, it may be advantageous to slow input shaft 18 rotation to improve shift or synchronizer performance. When the transmission control system 24 determines the need for input shaft 18 braking, hydraulic fluid or compressed air may be provided to the port 54. In either case, the fluid pressure applied to the brake piston 50 causes the brake piston 50 to shift toward the input shaft disk 40. The brake piston 50 engages the thrust bearing 60 that in turn engages the input shaft disk 40. Input shaft disk 40 is axially shifted within the inertia brake housing 34. Splines 42 and 44 permit the disk 40 to move axially to a limited extent allowing the input shaft disk 40 to be forced into engagement with brake disk 62. When the input shaft disk 40 engages the brake disk 62, rotation of the disk 40 is slowed as a result of the application of braking force. Brake disk 62 is grounded by means of the grounding teeth 66 to the recesses 68 formed in the inertia brake housing 34.

When the transmission control determines that sufficient braking force has been applied to the input shaft disk 40, the hydraulic or pneumatic fluid is exhausted through the port 54 as a result of the biasing force applied to the brake piston 50 by the return spring 70. The brake piston 50 shifts axially to disengage the input shaft disk 40 and eliminate the braking force applied to the input shaft disk 40.

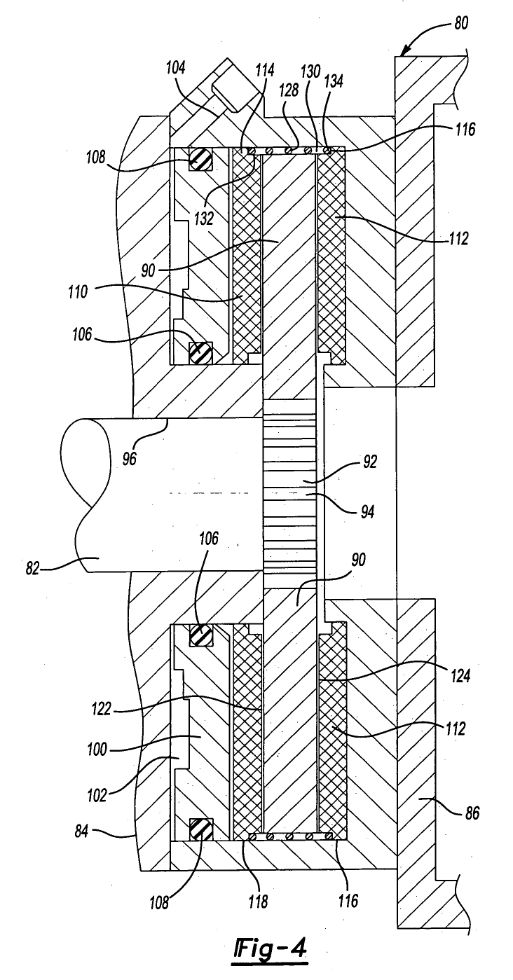

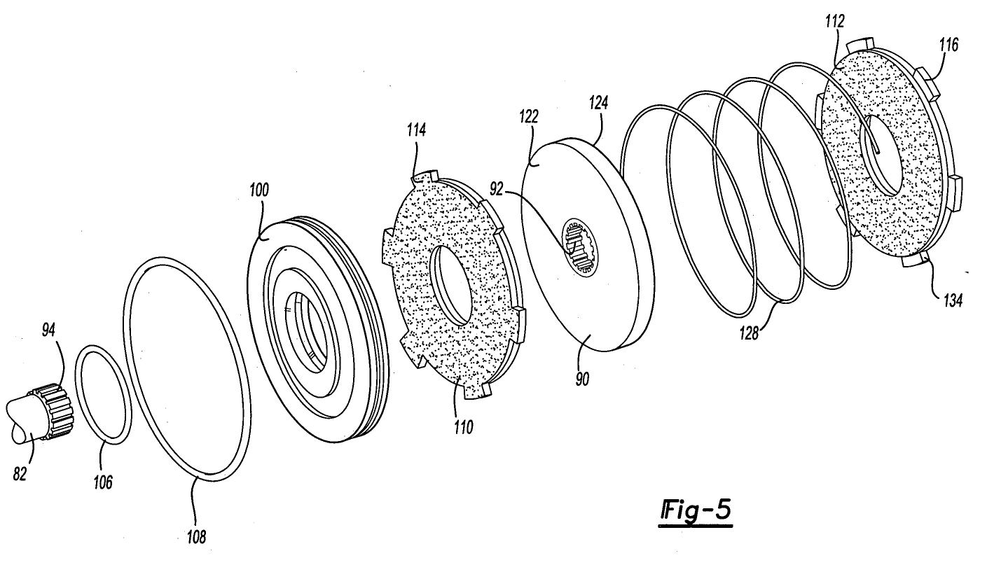

Referring now to FIGS. 4 and 5, an alternative embodiment of a transmission 80 is partially shown with its input shaft 82. The input shaft 82 is received within an inertia brake housing 84 or, alternatively, could be received within a transmission housing 86. An input shaft disk 90 rotates with the input shaft 82. Input shaft disk 90 has a plurality of splines 92 formed on its inner diameter that receive splines 94 formed on the input shaft 82. The input shaft 82 extends through an opening 96 formed in the inertia brake housing 84.

A brake piston 100 is disposed in a chamber 102 formed in the inertia brake housing 84. A port 104 opens into the chamber 102. Port 104 is connected to a source of fluid such as a hydraulic pump or air compressor that are controlled by the transmission controller. The control fluid is used to selectively move the brake piston 100 within the chamber 102.

The brake piston 100 has an inner O-ring seal 106 and an outer O-ring seal 108 that seal between the brake piston 100 and the chamber 102.

First and second brake disks 110 and 112 have first and second sets of grounding teeth 114 and 116 that ground the brake disks 110, 112 to the inertia brake housing 84. Axially relieved recesses 118 are provided in the inertia brake housing 84 for the grounding teeth 114 of the first brake disk 110. The axially relieved recesses 118 allow the first brake disk 110 to move to a limited extent in an axial direction when the brake piston 100 is axially shifted within the chamber 102. When the brake piston 100 is shifted within the chamber 102, first brake disk 110 engages a first side 122 of the input shaft disk 90 causing it to shift axially on the splines 92 and 94 until a second side 124 of the input shaft disk 90 engages the second brake disk 112. In this way, the first and second brake disks 110 and 112 engage opposite sides of the input shaft disk 90 to apply a braking force to the input shaft disk and slow rotation of the input shaft 82.

A return spring 128 is provided in an annular space 130 formed between the outer diameter of the input shaft disk 90 and the inertia brake housing 84. An angular groove 132 in the brake piston 100 receives one end of the return spring 128. The other end of the return spring 128 is received in an annular seat 134 formed in the inertia brake housing 84.

In operation, this alternative embodiment of the input shaft brake of the present invention is engaged during a shift operation as controlled by the transmission control. When the transmission control determines that it would be advantageous to apply a braking force to the input shaft 82, compressed air or hydraulic fluid is supplied to the chamber 102 through the port 104. The fluid exerts a force on brake piston 100 causing it to be axially shifted within the chamber 102. Brake piston 100 contacts the first brake disk 110 and shifts it to a limited extent in an axial direction toward the input shaft disk 90. Input shaft disk 90 is shifted into contact with the second brake disk 112. The first and second brake disks 110, 112 apply a braking force to first and second sides 122 and 124 of the input shaft disk 90. When the transmission control determines that sufficient braking force has been applied to the input shaft disk 90, the control fluid, either compressed air or hydraulic fluid, is exhausted through the port 104 as a result of the biasing force applied by the return spring 128 to the brake piston 100. When the brake piston 100 is shifted by the spring 128, the first and second brake disks 110, 112 cease applying brake pressure to the input shaft disk 90.

FIGS. 6 through 12 provide additional alternative embodiments of the invention that operate in a manner similar to the previously described embodiments. The following embodiments focus on different anti-rotation structures and combinations of braking elements that may be implemented within the spirit and scope of the invention. Other combinations are possible and the invention should not be limited to any approach.

Referring to FIG. 6, an alternative embodiment of the present invention is shown. A portion of a transmission housing 140 is shown in conjunction with a portion of an inertia brake housing 142. An input shaft 144 extends through the inertia brake housing 142 into the transmission housing 140. The inertia brake housing 142 defines a chamber 146 in which a piston 148 is contained for a limited degree of axial shifting relative to the input shaft 144. The piston 148 is prevented from axial rotation by bosses 150 that are integrally formed on the inertia brake housing 142 to extend into the chamber 146. The bosses 150 are received within receptacles 152 formed in the piston 148. The piston 148 is axially shiftable to engage a plate 154 which in turn engages a rotor 156 that is formed of friction material and may be a powder metal disk having friction material disposed in the matrix of the disk. A plate 158 is provided on the opposite side of the rotor 156 from the plate 154. When the piston 148 is shifted by hydraulic or pneumatic pressure described above with regard to the embodiments of FIGS. 1-6, the piston 148 shifts axially to cause the plate 154 to engage the rotor 156 that in turn engages the plate 158. Plate 158 is held against rotation by the inertia brake housing 142 that traps the plate 158 against the transmission housing 140. A bearing cap 160 is mounted to the transmission housing 140 that also engages a part of an antifriction bearing 162. Another part of the antifriction bearing 162 is secured to the input shaft 144. The input shaft 144 rotates with the rotor 156 and is supported within the bearing cap 160 by the antifriction bearing 162. The piston 148, plate 154, plate 158, and bearing cap 160 are non-rotatably attached between the transmission housing 140 and inertia brake housing 142.

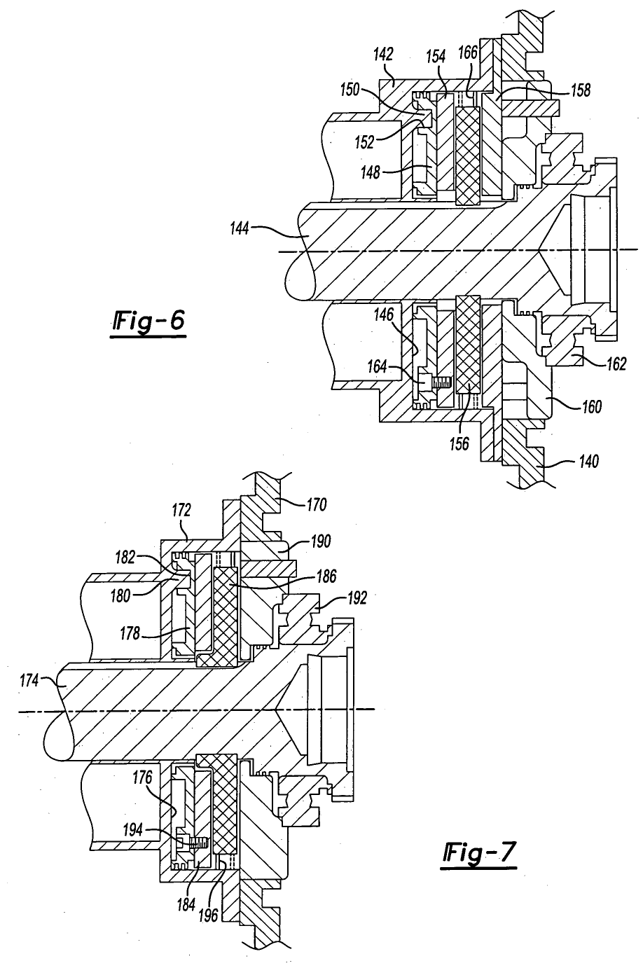

Referring to FIG. 7, another embodiment of the present invention is shown in which the transmission housing 170 and inertia brake housing 172 are assembled as previously described. An input shaft 174 extends through the inertia brake housing 172 and into transmission housing 170. The inertia brake housing 172 defines a chamber 176 in which a piston 178 is mounted for limited axial movement. The piston 178 is secured to a plurality of bosses 180 performed on the inertia brake housing 172. The bosses 180 are received within receptacles 182 formed on one side of the piston 178. A plate 184 is assembled around the input shaft 174 with a friction disk 186 and a bearing cap 190. The plate 184 is axially shifted by movement of the piston 178 against the plate 184 causing it to engage the rotor 186 that in turn is pressed against the bearing cap 190. A bolt 194 secures the piston 178 to the plate 184. The piston is prevented from rotation by the bosses 180 while the plate is held against rotation by the piston 178 which is connected to the plate by a bolt 194.

A wave spring 196 is provided radially outboard of the rotor 186. The wave spring 196 holds the plate 184 away from the bearing cap 190 so that normally, when no fluid pressure is applied to the piston 178, the plate 184 is held away from the rotor 186, and is also separated from the bearing cap 190.

Referring to FIG. 8, another alternative embodiment of the invention is shown in which a transmission housing 200 and inertia brake housing 202 are fragmentarily illustrated in conjunction with a portion of an input shaft 204 that extends through the inertia brake housing 202 and into the transmission housing 200. A chamber 206 is defined in the inertia brake housing 202. A piston 208 is disposed in the chamber 206. The piston 208 is axially shiftable to engage a plate 214 that is also axially shiftable relative to a friction disk 216. Plate 214 is grounded to the inertia brake housing 202 by teeth or splines (not shown) for preventing rotation. The friction disk 216 is assembled for rotation to the input shaft 204 and is axially shiftable to a limited extent so that it may engage bearing cap 220. Bearing cap 220 is stationary and is mounted in the transmission housing 200. A friction bearing 222 is provided between the bearing cap 220 and input shaft 204 to facilitate rotation of the input shaft 204 within the transmission housing 200 and inertia brake housing 202. A bolt 224 is provided to secure the bearing cap 220 to the transmission housing 200 and thereby prevent rotation of the bearing cap 220 with the input shaft 204. A wave spring 226 is provided radially outboard of the rotor or friction disk 216. The wave spring exerts a force on the plate 214 and bearing cap 220 to hold them apart and thereby permit the rotor 216 and the input shaft 204 to rotate freely whenever a pneumatic or hydraulic pressure is removed from the piston 208.

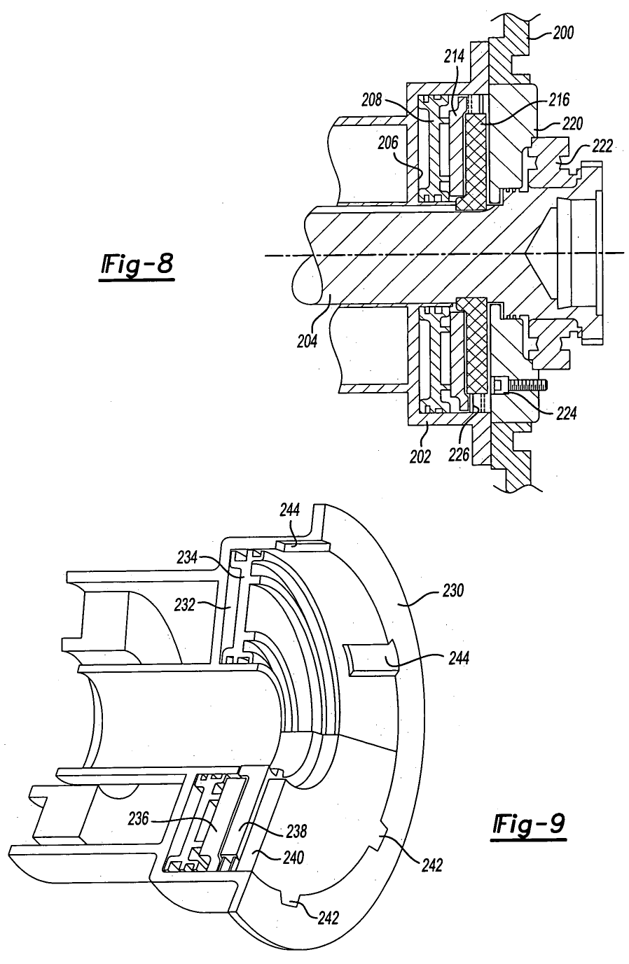

Referring to FIG. 9, an improved inertia brake housing 230 is shown that has a chamber 232 in which a piston 234 is received for limited axial movement. A front plate 236 is mounted concentrically with the piston 234 within the chamber 232. The front plate 236 is adapted to axially engage friction disk 238 when the piston 234 is axially shifted causing the front plate 236 and a rear plate 240 to engage opposite sides of the friction disk 238. The front plate 236 has teeth or splines (not shown) for preventing rotation. The rear plate 240 is prevented from rotating by the engagement of ribs 242, or grounding teeth, in corresponding slots 244 formed in the inertia brake housing 230. The slots 244 are elongated and also preferably received ribs or teeth (not shown) that are formed in the outer periphery of the front plate 236. Ribs 242 prevent the rear plate 240 from rotating.

Referring to FIG. 10, the transmission housing 250 and inertia brake housing 252 are shown assembled together with a piston 254 axially shiftably disposed within the inertia brake housing 252. Receptacles 256 formed in the piston 254 are adapted to receive bosses 258 that may be integrally formed in the inertia brake housing 252 for preventing rotation while allowing limited axial movement. The piston 254 in the illustrated embodiment directly engages a friction disk 260 that in turn engages a bearing cap 262. The piston 254 is shifted by the application of hydraulic or pneumatic pressure on the side of the piston 254 opposite the rotor 260. The rotor 260 is preferably formed of friction material embedded in a powder metal. The bearing cap 262 is retained within the transmission housing 250 and supports an outer race of the bearing 264. Inner race of the bearing 264 is secured to the input shaft 266 so that the input shaft 266 may rotate within the bearing cap 262 except for when the input shaft break is engaged. A wave spring 268 is assembled in an inertia brake housing 252 outboard of the rotor 260. The wave spring 268 functions to hold the piston 254 and bearing cap 262 apart from the rotor 260.

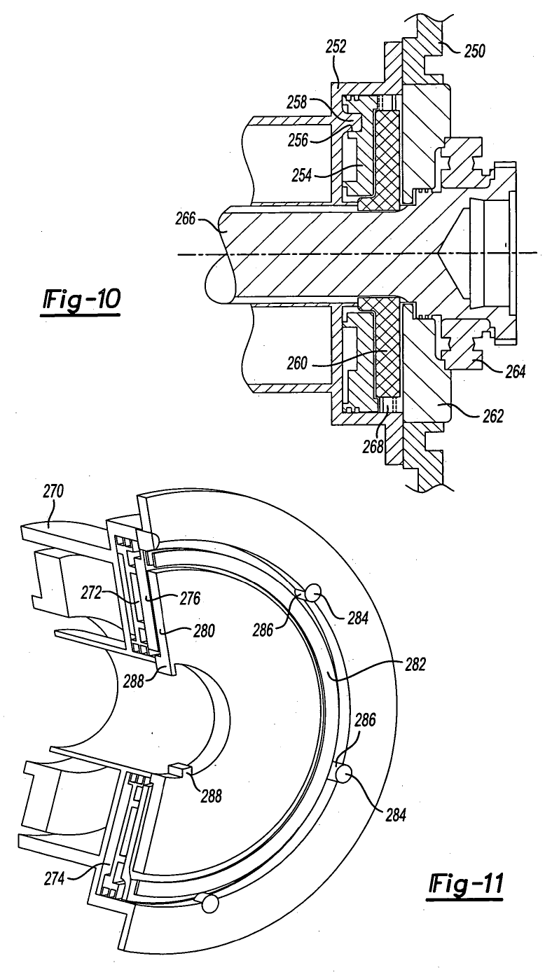

Referring to FIG. 11, an inertia brake housing 270 is shown for an alternative embodiment of the present invention. The inertia brake housing 270 encloses a piston 272 that is shiftable within a chamber 274 defined by the inertia brake housing 270. A plate 276 is mounted for limited axial shifting within the inertia brake housing 270. The plate 276 may be shifted when hydraulic or pneumatic pressure is applied to the piston 272 to cause the plate 276 to engage the rotor 280. Rotor 280 includes friction material and is preferably formed by a powder metal forming process. A wave spring 282 is assembled to the inertia brake housing 270 to apply a return force to the plate 276. Anti-rotation dowels 284 may be provided in bores 286 that are spaced around the inertia brake housing 270. The anti-rotation dowels 284 prevent rotation of the plate 276 while allowing axial movement. The inner diameter of the rotor 280 is provided with keys 288 that are used to secure the rotor 280 to an input shaft (not shown) but as previously described with reference to the preceding embodiments.

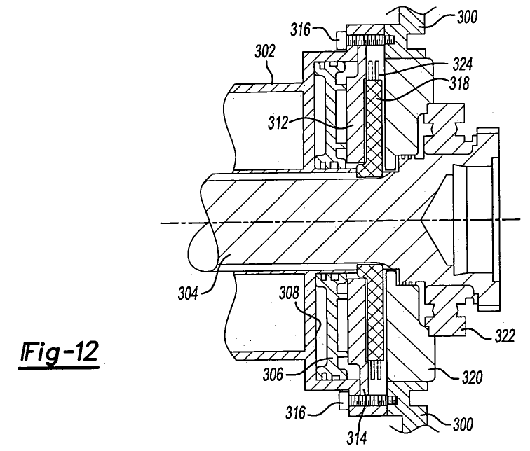

Referring to FIG. 12, a transmission housing 300 is shown in conjunction with an inertia brake housing 302 and input shaft 304. The input shaft 304 extends through the inertia brake housing 302 and into the transmission housing 300. A piston 306 is provided within a chamber 308 defined by the inertia brake housing 302. A plate 312 is engaged by the piston 306 that causes the plate 312 to be shifted when hydraulic or pneumatic pressure is applied to the piston 306. The plate 312 is prevented from rotating by circumferentially spaced notches in an outer edge flange 314 that allow the plate 312 to slide axially on shoulder bolts 316 that engage the friction disk, or rotor 318. When pressure is applied by the piston 306, the plate 312 is permitted to shift axially to engage a rotor 318 that is made of friction material. The rotor 318 also shifts axially to engage a bearing cap 320. A braking force is developed between the plate 312, rotor 318 and bearing cap 320 when pressure is applied by the piston 306. The bearing cap 320 is secured to the transmission housing 300 and also retains the outer race to the bearing 322. Bearing 322 supports on its inner race the input shaft 304 for rotation within the transmission housing 300 and inertia brake housing 302. A wave spring 324 exerts an outward force between the plate 312 and bearing cap 320 causing the plate 312 and bearing cap 322 to release the rotor 318 when no braking force is applied to the rotor 318 by the piston 306.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. In combination, a vehicle engine, a clutch, a multiple ratio geared transmission, and an input shaft inertia brake, the input shaft inertia brake comprising:
a housing disposed between the engine and the multiple ratio geared transmission;
an input shaft disposed at least in part within the housing;
a rotor secured to the input shaft between the clutch and the transmission;
a brake piston, axially movable relative to the input shaft and the housing between a braking position and a release position;
a disk brake plate grounded to the housing and mounted adjacent to the rotor for limited axial movement;
a fluid cavity defined by the housing and the brake piston;
at least one fluid port provided in the housing and in fluid flow communication with the fluid cavity, wherein fluid is supplied to the cavity through the fluid port to move the brake piston toward the braking position and shifting the disk brake plate relative to the rotor; and
a return spring applying a biasing force to move the brake piston toward the release position and shift the disk brake plate out of engagement with the rotor.

2. The combination of claim 1 further comprising:
a control system that controls the transmission to select a set of gears to transfer torque in the transmission; and
wherein the brake piston is actuated during a shift operation upon a determination that a change of gears is desired and prior to a shift engagement.

3. The combination of claim 1 further comprising a control system that controls the supply of fluid and wherein the fluid is hydraulic fluid that is supplied by a hydraulic pump supplied to the cavity through the fluid port.

4. The combination of claim 1 further comprising a control system that controls the supply of fluid and wherein the fluid is compressed air that is supplied by an air compressor supplied to the cavity through the fluid port.

5. The combination of claim 1 further comprising a control system having a first sensor for determining the speed of rotation of the input shaft, a driving gear attached to the input shaft and a second sensor for determining the speed of rotation of a driven gear in the transmission, wherein the control system controls the application of the inertia brake to reduce the speed of rotation of the input shaft to facilitate engagement of the drive gear and the driven gear.

6. The combination of claim 1 further comprising a thrust bearing disposed between the brake piston and the disk brake plate.

7. The combination of claim 1 further comprising means for inhibiting rotation of the brake piston.

8. A transmission system for a vehicle that has an engine comprising:
a clutch operatively connected to the engine for controlling the transfer of torque from the engine;
a multiple speed geared transmission having an input shaft that receives torque from the engine through the clutch;
a housing disposed between the engine and the transmission with the input shaft being disposed at least in part within the housing;
a rotor secured to the input shaft;
a brake piston axially movable relative to the input shaft and the housing;
first and second members grounded to the housing and mounted adjacent to opposite sides of the disk for axial movement relative to the rotor;
a fluid cavity defined on one side of the brake piston;
at least one fluid port provided in the housing and in fluid flow communication with the fluid cavity on the one side of the brake piston, wherein fluid is supplied to the cavity through the fluid port to move the piston to cause the first and second members to engage opposite sides of the rotor; and
a return spring disposed within the housing and applying a biasing force to the disk brake plate to urge the first and second members out of engagement with the rotor.

9. The transmission system of claim 8 wherein the rotor has friction material that increases the braking force when engaged by the first and second members.

10. The transmission system of claim 8 wherein the first member is a plate interposed between the piston and the rotor.

11. The transmission system of claim 8 wherein the first member is the surface of the piston facing the rotor.

12. The transmission system of claim 8 wherein the second member is a plate disposed between the rotor and a bearing cap.

13. The transmission system of claim 8 wherein the second member is a bearing cap.

14. The transmission system of claim 8 wherein at least one of the first and second members have structural features that are received by surface features formed in an interior portion of the housing.

15. The transmission system of claim 8 further comprising anti-rotation elements inserted between the housing and at least one of the first and second members to prevent rotation thereof.

16. The transmission system of claim 15 wherein the anti-rotation elements are dowel pins.

17. The transmission system of claim 15 wherein the anti-rotation elements are bolts.

18. The transmission system of claim 8 further comprising a control system having a first sensor for determining the speed of rotation of the input shaft and a driving gear attached to the input shaft and having a second sensor for determining the speed of rotation of a driven gear in the transmission, wherein the control system controls the application of the inertia brake to reduce the speed of rotation of the input shaft to facilitate engagement of the drive gear and the driven gear.

19. A method of controlling a multiple speed transmission system of a vehicle that has an engine having a crankshaft, the transmission system having a clutch and an input shaft brake that are disposed between the crank shaft of the engine and an input shaft of the transmission, a controller having a first sensor associated with the input shaft and a second sensor associated with an output shaft of the transmission, the method comprising:
determining the speed of rotation of a first rotating component attached to the input shaft;
determining the speed of rotation of a second rotating component attached to the output shaft;
applying a braking force with the input shaft brake to reduce the speed of rotation of the input shaft; and
coupling the input shaft to the output shaft by the transmission when the speed of rotation of the first and second rotating components are matched to within a predetermined degree of speed differential.

20. The method of claim 19 further comprising a synchronizer disposed in the transmission that synchronizes a drive gear with a driven gear, and wherein application of the input shaft brake reduces the speed of rotation of the input shaft and allows the synchronizer to synchronize the drive gear and driven gear in less time.
